(19) United States
(12) Patent Application Publication
(10) Pub. No.: US 2011/0236669 A1
(43) Pub. Date: Sep. 29, 2011

(54) Plastic panel having channels on both sides, and system and method for producing such panel

(76) Inventors: Dan Tal, Ramat Hashofet (IL); Yigal Steiner, Megiddo (IL); Mohammad Egbaria, Mosmos (IL); Yuri Pugach, Yokneam (IL)

(21) Appl. No.: 12/662,035

(22) Filed: Mar. 29, 2010

(51) Int. Cl. B32B 7/04; B29C 47/92

(52) U.S. Cl. 428/309.9; 425/112; 264/40.6

(57) ABSTRACT

A plastic panel having channels on both sides, and system and method for producing such panel. For example, a panel is comprised of: first and second walls of plastic interconnected with one another by a set of plastic connecting structures; wherein said walls of plastic are generally parallel to one another and generally perpendicular to said plastic connecting structures; wherein at least one of said walls of plastic comprises an at least one indented channel running generally parallel to at least one of said plastic connecting structures without being in contact with any of said plastic connecting structures.

### FIELD

Some embodiments are related to the field of plastic products.

### BACKGROUND

A wide range of industrial and consumer products are made of plastic, which is a synthetic or semi-synthetic solid material, typically a polymer of high molecular mass. Plastic materials include, for example: Polypropylene (PP), which may be used to manufacture food containers, light furniture, car fenders, and other products; Polyester (PES), which is used in the textile industry; Polyurethanes (PU), which may be used to produce cushioning foams and thermal insulation foams; and various other types of plastics.

Plastic-based products may be manufactured in various methods, for example: extrusion and molding, injection molding, blow molding, or other suitable processes. For example, in an injection molding process, thermoplastic materials may be fed into a heated barrel, and are mixed and then fed into a mold cavity (e.g., made of steel) in which they cool and harden to the shape of the mold cavity. Other suitable processes may be used.

### SUMMARY

Some embodiments include, for example, a plastic panel having channels or slits on both sides, and systems and methods of producing such panel.

In some embodiments, for example, a panel is comprised of: first and second walls of plastic interconnected with one another by a set of plastic connecting structures; wherein said walls of plastic are generally parallel to one another and generally perpendicular to said plastic connecting structures; wherein at least one of said walls of plastic comprises an at least one indented channel running generally parallel to at least one of said plastic connecting structures without being in contact with any of said plastic connecting structures.

In some embodiments, for example, the panel is formed of Polypropylene.

In some embodiments, for example, the panel is formed of Polypropylene, an ultraviolet stabilizer, and one or more colorants.

In some embodiments, for example, each one of said walls of plastic comprises an at least one indented channel running generally parallel to at least one of said plastic connecting structures without being in contact with any of said plastic connecting structures.

In some embodiments, for example, A system for producing a plastic panel comprises: an extrusion molding dye comprising openings defining first and second walls and a set of connecting structures, wherein said walls are generally parallel to one another and generally perpendicular to said connecting structures; a pressure source adapted to apply pressure to a partially liquefied mixture of plastic such that the mixture is forced through said dye; and a channel indenting assembly comprising: (a) a channel pressing element; (b) a heating element adapted to heat said channel pressing element; and (c) a heating element control circuit comprising: a temperature sensor, and regulated heating element power source adapted to regulate power delivery to said heating element based on a signal received from said sensor.

In some embodiments, for example, said signal received from said sensor comprises one or more of: temperature of a heating element, temperature of a channel, and temperature of a region of the plastic panel in proximity to a channel.

In some embodiments, for example, said heating element control circuit comprises: a set of sensors adapted to sense temperatures at a plurality of locations, wherein said control circuit is adapted to derive a work function associated with the heating element based on a set of signals received from said set of sensors.

In some embodiments, for example, the system further comprises: a mixer adapted to mix plastic material, stabilizer, and one or more colorants to result in a mixture; and a melting unit adapted to melt said mixture resulting in said partially liquefied mixture of plastic.

In some embodiments, for example, said plastic material comprises Polypropylene.

In some embodiments, for example, said stabilizer comprises ultraviolet stabilizer.

In some embodiments, for example, the system further comprises: an annealing oven adapted to anneal the plastic panel.

In some embodiments, for example, the channel indenting assembly comprises a controller adapted to perform at least one of the following operations: determining to perform a subsequent pressing of a particular heating element; determining to terminate subsequent pressing by a particular heating element; modifying a temperature of a particular heating element; modifying a time-length in which a particular heating element is to press onto the plastic panel; modifying a time interval between two consecutive presses of a particular heating element onto the plastic panel.

In some embodiments, for example, a method of producing a plastic panel comprises: applying pressure to a partially liquefied mixture of plastic such that the mixture is forced through a dye including openings defining first and second walls and a set of connecting structures, wherein said walls are generally parallel to one another and generally perpendicular to said connecting structures; pressing a channel in at least one wall of the panel by pressing a heated channel pressing element against a wall; and regulating power delivery to a heating element connected to the channel pressing element based on a signal received from a temperature sensor functionally associated with the heating element.

In some embodiments, for example, said signal received from said sensor comprises one or more of temperature of a heating element, temperature of a channel, and temperature of a region of the plastic panel in proximity to a channel.

In some embodiments, for example, the method further comprises: deriving a work function associated with the heating element based on a set of signals received from one or more temperature sensors.

In some embodiments, for example, the method further comprises: mixing plastic material, stabilizer, and one or more colorants to result in a mixture; and melting said mixture to result in said partially liquefied mixture of plastic.

In some embodiments, for example, the method further comprises: annealing the plastic panel.

In some embodiments, for example, said plastic material comprises Polypropylene.

In some embodiments, for example, said stabilizer comprises ultraviolet stabilizer.

In some embodiments, for example, the method further comprises: controlling a set of heated channel pressing elements by performing at least one of the following operations: determining to perform a subsequent pressing of a particular heated channel pressing element; determining to terminate subsequent pressing by a particular heated channel pressing element; modifying a temperature of a particular heated channel pressing element; modifying a time-length in which a particular heated channel pressing element is to press onto the plastic panel; modifying a time interval between two consecutive presses of a particular heated channel pressing element onto the plastic panel.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments.

FIGS. 2A-2B are schematic illustrations of a panel in accordance with some demonstrative embodiments.

FIG. 3 is a schematic flow-chart of a method of manufacturing a panel in accordance with some demonstrative embodiments.

FIGS. 4A-4B are schematic illustrations of a channel creation unit, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Although portions of the discussion herein relate, for demonstrative purposes, to manufacturing of a plastic “panel” having slits on both sides, some embodiments may be used in order to manufacture other suitable plastic or plastic-based products, for example, walls, fences, dividers, separators, partitions, barricades, barriers, screens, gates, doors, or the like.

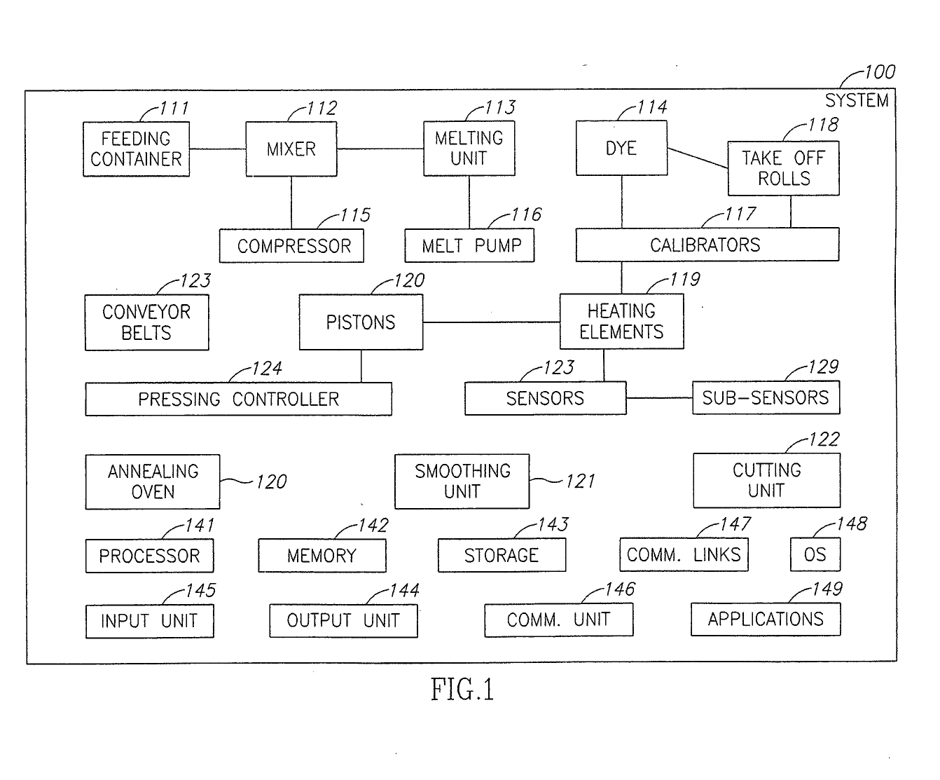

Reference is made to FIG. 1, which is a schematic block diagram illustration of a system 100, in accordance with some demonstrative embodiments. System 100 may be used, for example, for producing or manufacturing one or more plastic panels or plastic-based panels. System 100 may be implemented, for example, as a stand-alone or dedicated system, as an assembly of units or sub-units, as a manufacturing line, as a part of a manufacturing line, or the like.

System 100 may include a feeding container 111 or other suitable receptacle, cell, or compartment, into which multiple materials are inserted. The materials may include, for example, Polypropylene (PP) or other suitable plastic or polymer; Ultraviolet (UV) light stabilizer which may protect the final product from long-term degradation of effects of UV light; and one or more colorants. The UV stabilizer may include, for example, the material known as “UV 3855 PE” available from the vendor “Tosaf Compounds Ltd.” of Afula, Israel (www.Tosaf.com), and/or other suitable materials.

The Polypropylene, the UV stabilizer, and the colorants may be inserted into the feeding container 111 serially or in parallel, at a suitable ratio among them. In some embodiments, for example, the ratio may be: approximately 96 percent of Polypropylene, approximately 2 percent of UV stabilizer, and approximately 2 percent of colorant(s). Other suitable ratios may be used in some embodiments.

The materials in the feeding container 111 may be mixed, for example, using a mixer 112 or other suitable mixing unit, for example, for a period of several minutes. The mixture may then undergo a melting or fusion process, using a melting unit 113 able to bring the mixture to a temperature of approximately 180 to 190 degrees Celsius. The melting unit 113 may be electrical, may include one or more electrical heating elements, and may operate for several minutes until the mixture is substantially melted.

The melted materials, which may be referred to as “melt”, may be inserted or squeezed or compressed into a dye 114 (e.g., an extrusion molding dye) having a particular shape and form. For example, the dye 114 may include openings that define first and second external walls of a panel to be manufactured, as well as a set of interior walls or other connecting structures. The melting unit 113 may include a compressor 115 or other pressure source adapted to apply pressure to a partially liquefied mixture of plastic such that the mixture is forced through the dye 114, e.g., a rotatable screw able to rotate and thereby press or push forward the melt into the dye 114. In some embodiments, a melt pump 116 may operate to regulate or control the movement of the melt into the dye 114, for example, since the natural flow of the melt from the compressor 115 may not necessarily be at a constant rate. The dye 114 receives the melt, and ensures that the melt takes the particular geometric shape of the dye 114.

The melt is then pulled out from the dye 114, by one or more take-off rolls 118, onto calibrators 117 which may include cooling plates at a temperature of approximately 5 degrees Celsius. The calibrators 117 may reach and/or remain at such temperature by various cooling methods, for example, by utilizing streams or flows of cold water in proximity to metal plates of the calibrators 117. The calibrators 117 may be smooth and planar, for example, such that the melt assumes a smooth and planar form when it solidifies on the calibrators 117, and/or in order to reduce friction due to the relative movement of the solidifying melt on the calibrators 117.

The melt may remain on the calibrators 117, for example, for a period of several minutes. The melt may solidify to reach its substantially final form (but excluding the slits or channels, described herein) on the calibrators 117, within several minutes. One or more take-off rolls 118 may operate near the calibrators 117 in order to pull the cooled melt from the calibrators 117, or to otherwise move the cooled melt from the calibrators 117 to the next sub-unit of system 100. In some embodiments, for example, the melt may take the form of a panel, by moving onto the cool calibrators at a temperature of approximately 5 degrees Celsius.

In some embodiments, for example, the melt which solidifies into a panel may have a length of approximately 4 meters, and may move at a rate of approximately one meter per minute, such that the panel is on the calibrators for approximately 4 minutes. Other suitable sizes or time-periods may be used, such that the melt substantially completely solidifies on the calibrators 117 and exits the calibrators 117 at a substantially solid state, for example, as a panel having two substantially smooth and planar sides.

System 100 may further include a channel indenting assembly, for example, a set of heating elements 119 (or other channel pressing elements) operated by a set of pneumatic pistons 120. For example, the heating elements 119 may be at a temperature of approximately 220 to 230 degrees Celsius; and multiple heating elements (e.g., five, seven, ten, or the like) may be arranged in a line or in other suitable shapes. Each one of the heating elements 119 may be substantially smooth, and may optionally be ring-shaped, or may include a cylinder having thereon a ring-shaped cross-section, or may include an arc or a curve having a width of approximately one centimeter or other suitable width. The heating elements 119 may be electrical, and may continuously remain connected to an electric power source (or other heating element power source or heat source) during their operation, in order to maintain their heat during their operation.

The pneumatic pistons 120 are controlled to press the heating elements 119 onto the solid panel, and then to depress the heating elements 119 from the solid panel, in a regulated manner. In some embodiments, the heating elements 119 are in contact with the panel for a short period of time, for example, half a second, one second, two seconds, or three seconds; and then they are depressed or removed from the panel by the pneumatic pistons 120. This may be repeated for multiple iterations, such that the repeated pressing of the heating elements 119 onto the solid panel produces a local melting of the solid panel, thereby resulting in slits or channels in accordance with the shape and the locations of the heating elements 119. In some embodiments, a single iteration of pressing may suffice; in other embodiments, multiple repeated iterations of pressing may be used. In some embodiments, during the pressing of the heating elements 119 onto the solid panel, the solid panel may be at room temperature, namely, at a non-heated state and a non-cooled state.

In some embodiments, system 100 may operate to produce the solid panel such that the solid panel has slits or channels in both of its sides. In some embodiments, a first set of heating elements 119 operates on a first side of the panel in order to create the slits or channels on the first side; and then, as the panel moves forward in the manufacturing system 100, a second set of heating elements 119 operates on a second side of the panel in order to create the slits or channels on the second, opposite, side. In other embodiments, the two sets of heating elements 119 may operate in parallel, on both sides of the panel, for example, by using a conveyor belt or other carrier which may have holes in it or may have cavities to allow the operation of the heating elements 119 through it. In other embodiments, system 100 may include a unit to flip or turn the solid panel, such that the same set of heating elements 119, or two sets of heating elements 119 which are located serially on the same side of the panel, operated on both sides of the panel serially. Other suitable mechanisms may be used to create the slits or channels on both sides of the solid panel, serially or in parallel.

In some embodiments, the heating elements 119 may be accompanied by one or more sensors 123 able to sense the temperature and/or the pressure or resistance at the region in the panel onto which the heating elements are pressed. In some embodiments, substantially each heating element 119 may be associated with a local sensor 123 able to sense or measure these parameters in proximity to the heating element 119. In other embodiments, a sensor 123 may correspond to two or more heating elements.

In some embodiments, each sensor 123 may include multiple sub-sensors, for example, four disk-shaped sub-sensors 129, which may be located along the corresponding heating element 119 or in proximity to it. This may be required, for example, since different portions or regions of the panel may have different temperatures or characteristics: for example, an area of the panel which is closer to the edge of the panel may cool down more rapidly than an internal or central area of the panel which may cool down more slowly. The utilization of multiple sub-sensors 129 may allow each heating element 119, which may be used to create an elongated slit of channel, to be associated with multiple measurements of temperature and/or pressure. In some embodiments, measures from multiple sub-sensors 129 may be used by a suitable controller or circuit in order to compute or derive a work function associated with a heating element 119 or with a set of heating elements 119.

The data measured by each sensor 119 may be transferred to a pressing controller 124, or other suitable heating element control circuit, able to aggregate the data and process the collected data in order to determine, control and/or modify the temperature of the subsequent press by the heating elements 119 and/or the pressure to be applied in the subsequent press by the heating elements 119. In some embodiments, the pressing controller may control and/or regulate, individually and/or separately, substantially each one of the heating elements 119, the pressure applied by such heating element 119, the power delivered or provided to each heating element 119, the temperature of such heating element 119, the time interval between consecutive presses, and the termination of the pressing process. In other embodiments, the pressing controller 124 may control multiple heating elements 119 as a set or series. In some embodiments, the controlling or regulating may be performed in order to ensure that the panel does not collapse or break, and that the slits or channels are produced at the appropriate depth. In some embodiments, small changes in the thickness of the external walls of the panel being manufactured (e.g., changes of approximately 0.1 or 0.2 millimeters, relative to an external wall thickness of approximately 0.7 or 0.8 millimeters), may require individual and/or separate control and regulation of each one of the heating elements 119, by the pressing controller 124.

In some embodiments, system 100 may thus allow selective and specific regulation and control of the heating, the pressing, the timing, and other characteristics of the press, individually for each one of the heating elements 119, in order to accommodate slight differences among various regions of the panel being produced, and in order to allow creation of slits or channels across a panel having thin external walls (e.g., with external wall thickness of approximately 0.7 to 0.8 millimeters) without causing local collapse of the external wall or panel.

The panel may then be transported or moved into an oven, for example, an annealing oven 120, in order to heat or warm the panel, thereby releasing or removing mechanical pressures or constraints which the panel may absorb during the previous steps in the manufacturing process. The annealing oven 120 may be conveyor-based or conveyorized, or may otherwise allow entry of the panel thereto and exit of the panel therefrom. In some embodiments, for example, the annealing oven 120 may include relatively small apertures or openings to allow the panel to enter the annealing oven 120, and subsequently to exit from the annealing oven 120. In some embodiments, the temperature within the annealing oven may be modified gradually, and may range, for example, from approximately 90 to 100 degrees Celsius. In some embodiments, the panel may undergo an initial step of higher-degree heating upon entry into the annealing oven 120, which may then change into a gradually-changing temperature. In some embodiments, the panel may substantially continuously move within the annealing oven 120, from exit until entry; for example, for a period of approximately three minutes. Other suitable temperatures and/or time periods may be used.

In some embodiments, system 100 may optionally include a smoothing unit 121 which may slightly press the panel or may slightly scratch the panel in order to provide to the panel a wood-like appearance. In some embodiments, the optional smoothing unit 121 may be internal to the annealing oven 120, or may be a separate unit.

In some embodiments, system 100 may further include a cutting unit 122 having one or more knives or saws able to cut the panel into particular sizes and/or shapes (e.g., rectangular of square). For example, system 100 may be able to produce original panels measuring approximately 8 meters long, by 1 or 2 meters wide; and then, cutting unit 122 may cut such elongated panels to pre-defined measures, for example, approximately 2 by 2 meters, or approximately 1 by 2 meters, or the like. In some embodiments, optionally, the cutting unit 122 may cut-off and remove margins from the panel; for example, a panel having an original width of 200 centimeters, may be cut at its margins to leave a net width of approximately 190 centimeters. In some embodiments, the panel may be manufactured at a pre-defined height or thickness, for example, approximately 12 millimeters, approximately 12 millimeters, approximately 13 millimeters, approximately 14 millimeters, approximately 15 millimeters, approximately 16 millimeters, or the like. Other suitable dimensions may be used.

In some embodiments, system 100 may optionally include one or more sets of conveyors or conveyor belts 123, able to move the panel from one sub-unit of system 100 to another sub-unit of system 100.

In some embodiments, system 100 may include additional hardware components and/or software components in order to implement or assist the other sub-units of system 100, for example, in order to perform data collection, data analysis, and automatic or semi-automatic regulation of sub-units of system 100. Such components may include, for example, a processor 141 able to process data, implemented using a general-purpose processor or controller, a dedicated processor or controller, an Integrated Circuit (IC), or the like; a memory unit 142 able to store data for short terms; a storage unit 143 able to store data for long terms; an output unit 144 (e.g., a screen or monitor) able to present output about the operation of system 100; an input unit 145 able to receive input related to the operation of system 100 (e.g., to receive input indicating the desired depth of slits or channels to be produced, or input indicating the desired dimensions of panels to be produced); a wired or wireless communication unit 146 (e.g., to allow communication with other systems and/or within the system 100); one or more wired and/or wireless communication links 147, to allow communication among components of system 100; an Operating System (OS) 148 and one or more software applications 149; and/or other suitable hardware components and/or software modules.

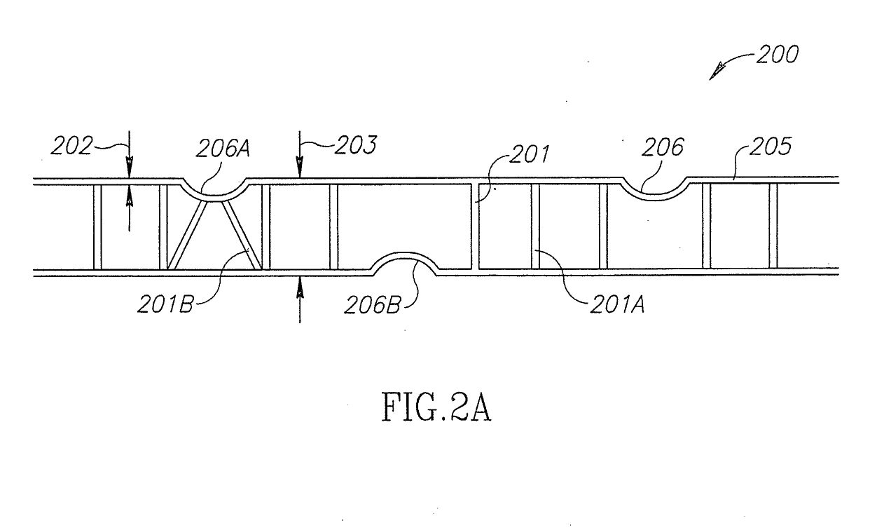

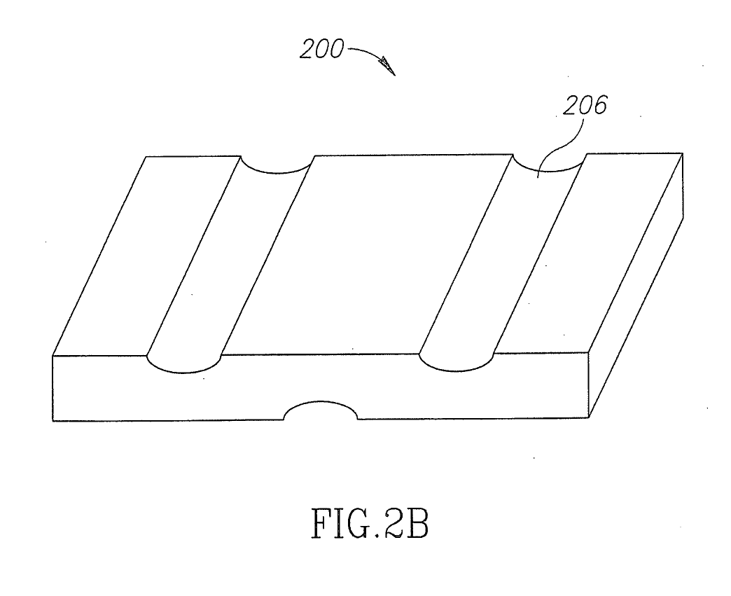

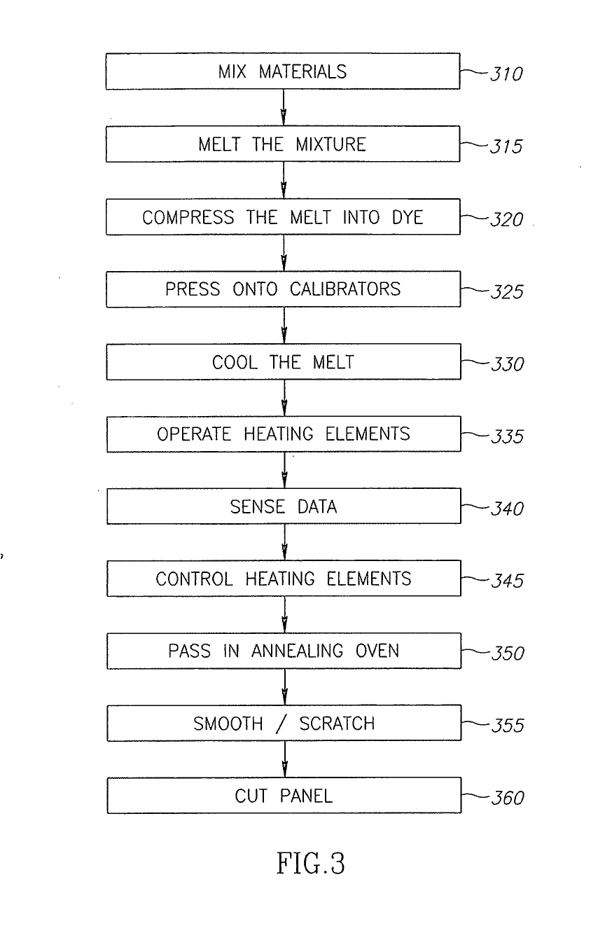

Reference is made to FIG. 2A, which is a schematic side-view illustration of a panel 200, in accordance with some demonstrative embodiments; and to FIG. 2B, which is a schematic isometric illustration of panel 200, in accordance with some demonstrative embodiments. Panel 200 may be manufactured, for example, by utilizing the system 100 of FIG. 1, or by using the manufacturing process of FIG. 3, or by other suitable systems and/or methods.

In some embodiments, panel 200 may substantially hollow or at least partially hollow, for example, in order to reduce consumption of plastic material and/or in order to achieve a relatively light-weight panel 200. Optionally, panel 200 may include internal supporting walls 201, which may be substantially perpendicular to the long plane or the long dimension of panel 200. In some embodiments, a single or common type of internal supporting'walls 201 (which may also be referred to as plastic connecting structures) may be used. In other embodiments, two or more types of internal supporting walls 201 may be used, for example: supporting walls 201A which may be substantially perpendicular to the long plane or the long dimension of panel 200; and supporting walls 201B which may be diagonal or slanted (e.g., at an angle of approximately 45 or 60 or 75 degrees) relative to the long plane or the long dimension of panel 200.

In some embodiments, the thickness of each external wall 205 of the panel 200 (indicated with a pair of thickness arrows 202) may be approximately 0.7 or 0.8 millimeters. In some embodiments, the entire thickness of the panel 200 (indicated with a pair of thickness arrows 203) may be approximately 12 millimeters, approximately 13 millimeters, approximately 14 millimeters, approximately 15 millimeters, approximately 16 millimeters, or the like. Other suitable thickness values or dimensions may be used.

In some embodiments, application of heat and/or pressure onto the panel 200, during the manufacturing process, may cause thinning of the external wall 205 of panel 200 being pressed and/or heated; for example, from an original thickness of approximately 0.7 or 0.8 millimeters to a reduced thickness of approximately 0.5 or 0.6 millimeters. In some embodiments, this may be prevented due to the particular controlling of each heating element (e.g., heating element 119 of FIG. 1), its pressure, its temperature, the time interval between its pressings, the termination of the pressing process, or other parameters. The controlling may thus prevent breaking or tearing of an external wall 205 of the panel 200, or a local collapsing of the panel 200 at or near the region in which the pressing and/or heating are applied.

In some embodiments, the controlled application of heated pressure on the panel 200 during its manufacturing process, may result in the creation of indented slits or channels 206 on both sides of the panel 200, without tearing the panel 200 and without causing local collapsing thereof.

In some embodiments, a slit or channel 206A may be of a type which requires internal supporting walls 201 to prevent a local collapse of the panel 200. Additionally or alternatively, in the same panel 200 or in another panel 200, a slit or channel 206B may be of a type which does not require internal supporting walls 201 to support a local collapse of the panel 200. In some embodiments, a panel 200 may have slits or channels which may be similar to slit or channel 206A, on one side or on both sides; and/or, slits or channels which may be similar to slit or channel 206B, on the same side or on the opposite side or on both sides. In some embodiments, for example, slit or channel 206B may not have any internal supporting walls 201 to support it, neither vertical (e.g., perpendicular) supporting walls 201A nor slanted internal supporting walls 201B; whereas slit or channel 206A may have supporting walls, e.g., slanted internal supporting walls 201B or other type of internal supporting walls 201. In some embodiments, the determination whether or not to include internal supporting walls 201 under or near a slit or channel 206 may be pre-determined at the manufacturing stage in which the panel 200 is being cooled down using calibrators; or may be determined at other or later stages of the manufacturing process.

In some embodiments, the distance between two adjacent channels 206 located on the same side of the panel 200 may be, for example, K times the thickness of panel 200; wherein K denotes a number (integer or non-integer) greater than two. For example, in some embodiments, the value of K may be 2, or 2, or 4, or 5, or 6, or 7, or 8, or 10, or 12, or 15, or 18, or 20, or 25, or other suitable integer or non-integer values. In some embodiments, the distance between a first channel 206 and a second, adjacent, channel 206 may be substantially identical to, or may be different from, the distance between two other adjacent channels 206 on the same side of the panel 200 or on the other side of the panel 200.

FIG. 3 is a schematic flow-chart of a method of manufacturing a panel in accordance with some demonstrative embodiments. The method of FIG. 3 may be used, for example, by system 100 of FIG. 1, or by other suitable systems or devices. The method of FIG. 3 may be used, for example, to manufacture the panel 200 of FIGS. 2A-2B, or to manufacture other suitable panels.

In some embodiments, the method may include, for example, mixing Polypropylene (PP) with UV stabilizer and with one or more colorant(s) (block 310).

In some embodiments, the method may include, for example, melting the mixture (block 315).

In some embodiments, the method may include, for example, compressing the melt into a dye (block 320).

In some embodiments, the method may include, for example, pressing the compressed melt from the dye onto calibrators (block 325).

In some embodiments, the method may include, for example, cooling the melt on the calibrators to result in one or more panels (block 330).

In some embodiments, the method may include, for example, repeatedly operating one or more heating elements to press on the one or more panels, on one side of the panels or on both sides of the panels, in series or in parallel (block 335).

In some embodiments, the method may include, for example, sensing characteristics of the one or more panels or of one or more of the heating elements or other components of the system (block 340); for example, sensing temperature at multiple points in proximity to the area in which the heating element(s) press the one or more panels.

In some embodiments, the method may include, for example, controlling the operation of the heating elements based on the sensed data (block 345). The controlling may include, for example, terminating the pressing iterations; modifying the time interval between pressing iterations; modifying the temperature of the heating element(s); modifying the time-length of the pressing; modifying the force applied through the pressing; selectively and/or individually determining and/or modifying such operational parameters for each heating element, separately and/or in series and/or in parallel; or the like.

In some embodiments, the method may include, for example, passing the one or more panels through an annealing oven (block 350).

In some embodiments, the method may optionally include, for example, smoothing and/or scratching the one or more panels (block 355), for example, in order to produce a wood-like appearance.

In some embodiments, the method may optionally include, for example, cutting the one or more panels (block 360), for example, in accordance with pre-defined shapes and/or dimensions.

Other suitable operations or sets of operations may be used in accordance with some embodiments. Some operations or sets of operations may be repeated, for example, substantially continuously, for a pre-defined number of iterations, or until one or more conditions are met. In some embodiments, some operations may be performed in parallel, in sequence, or in other suitable orders of execution.

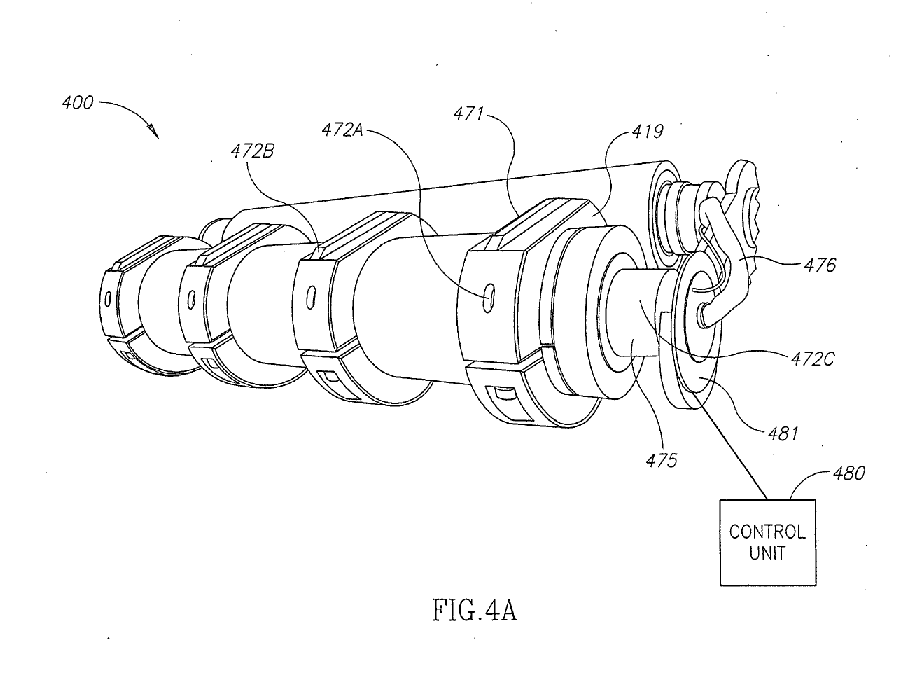

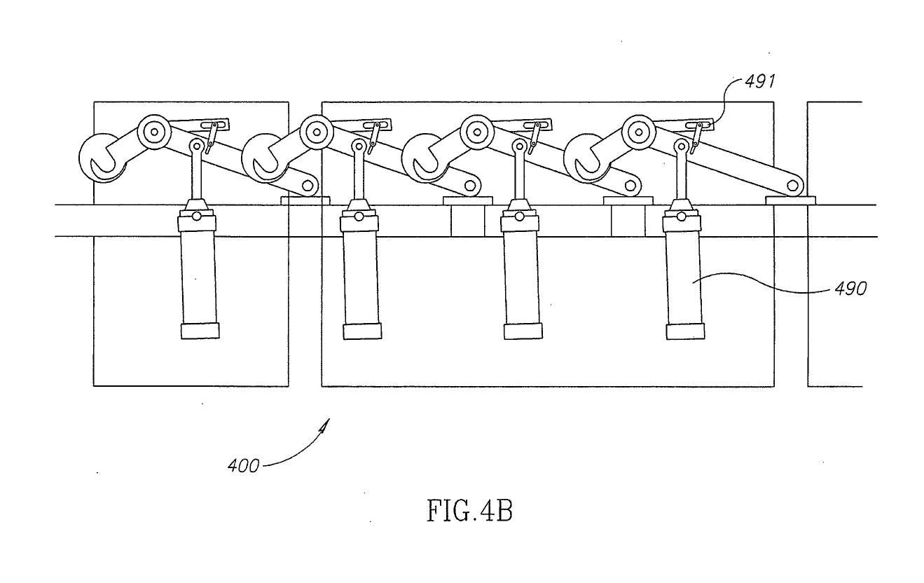

Reference is made to FIGS. 4A and 4B, which are schematic illustrations of a channel creation unit 400, in accordance with some demonstrative embodiments. Channel creation unit 400 may be, for example, a demonstrative example of a set of heating elements 119 of FIG. 1. Channel creation unit 400 may be used in conjunction with other suitable systems.

Channel creation unit 400 may include one or more heating elements 419, which may generally correspond to heating elements 119 of FIG. 1. In a demonstrative example, each heating element 419 may be generally ring-shaped; or may be shaped as an incomplete ring or a cropped ring, having a substantially planar or rectangular contact region 471 which may be the area or region of heating element 419 which comes into contact with the panel being manufactured and/or which presses onto or into the panel being manufactured.

The channel creation unit 400 may include a heat source 475, which may be individual to each heating element 419 or may be common to some or all of the heating elements 419. The heat source 475 may be electrical, and may be connected through wires or cables 476 to a suitable electrical power source.

The channel creation unit 400 may include one or more pistons 490, which may be individual to each heating element 419 or may be common to some or all of the heating elements 419. The pistons 490 may be operable and/or controllable to lift or push a heating element 419 (or several heating elements 419); to lower or pull a heating element 419 (or several heating elements 419); to press (e.g., onto or into the panel) a heating element 419 (or several heating elements 419); and/or to depress or withdraw (e.g., away from the panel) a heating element 419 (or several heating elements 419). Each one of the pistons 490 may include, for example, a force controller 491 able to control, set, increase and/or decrease the amount of force applied to such movement(s) of the piston 490, and/or able to control the direction(s) of such movement(s) of the piston 490.

The channel creation unit 400 may further include one or more sensors 472, for example, temperature sensors, which may be positioned or located in various locations or areas of the channel creation unit. In some embodiments, for example, sensors 472 may include one or more sensors 472A located on a side region of heating element 419; one or more sensors 472B located on or at the contact region 471 of heating element 419; one or more sensors 472C located on the heat source 475 or in proximity thereto; or the like. Other suitable sensing locations may be used.

The data sensed or measured by the sensors 472 may be transferred to a control unit 480, for example, via wired and/or wireless communication. The control unit 480 may collect and analyze the received data, and may control the operation of a heating regulator 481, for example, in order to increase and/or decrease the heating provided by the heat source 475 to a particular heating element 419 or to some or all of the heating elements 419. The control unit 480 may further control the operation of the one or more pistons 490, for example, in order to command the pistons 490, individually or cumulatively as a set, to pull, to push, to lift, to remove, to withdraw, to press and/or to depress; and/or in order to control, set or modify the force applied to such movements, or the direction(s) of such movements.

In some embodiments, the channel creation unit 400 may include other suitable components or sub-units. For example, each heating element 419 may be constructed or implemented as a ring able to controllably expand or contract, or as a ring whose diameter may be controllably increased or decreased; and/or as a ring which may be slightly moved or adjusted, or having a location or position or angular direction which may be slightly moved or adjusted. These modifications may be performed by the control unit 480, in response to data sensed by the sensors 472, and may thus modify the characteristics of the pressure applied by the heating elements 419 toward the panel being manufactured.

The terms “plurality” or “a plurality” as used herein include, for example, “multiple” or “two or more”. For example, “a plurality of items” includes two or more items.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the following claims are intended to cover all such modifications, substitutions, changes, and equivalents.

What is claimed is:

1. A panel comprised of:
first and second walls of plastic interconnected with one another by a set of plastic connecting structures,
wherein said walls of plastic are generally parallel to one another and generally perpendicular to said plastic connecting structures,
wherein at least one of said walls of plastic comprises an at least one indented channel running generally parallel to at least one of said plastic connecting structures without being in contact with any of said plastic connecting structures.

2. The panel of claim 1, wherein the panel is formed of Polypropylene.

3. The panel of claim 1, wherein the panel is formed of Polypropylene, an ultraviolet stabilizer, and one or more colorants.

4. The panel of claim 1, wherein each one of said walls of plastic comprises an at least one indented channel running generally parallel to at least one of said plastic connecting structures without being in contact with any of said plastic connecting structures.

5. A system for producing a plastic panel, the system comprising:
an extrusion molding dye comprising openings defining first and second walls and a set of connecting structures, wherein said walls are generally parallel to one another and generally perpendicular to said connecting structures;
a pressure source adapted to apply pressure to a partially liquefied mixture of plastic such that the mixture is forced through said dye; and
a channel indenting assembly comprising:
a channel pressing element;
a heating element adapted to heat said channel pressing element; and
a heating element control circuit comprising: a temperature sensor, and regulated heating element power source adapted to regulate power delivery to said heating element based on a signal received from said sensor.

6. The system of claim 5, wherein said signal received from said sensor comprises one or more of:
temperature of a heating element,
temperature of a channel, and
temperature of a region of the plastic panel in proximity to a channel.

7. The system of claim 5, wherein said heating element control circuit comprises:
a set of sensors adapted to sense temperatures at a plurality of locations,
wherein said control circuit is adapted to derive a work function associated with the heating element based on a set of signals received from said set of sensors.

8. The system of claim 5, further comprising:
a mixer adapted to mix plastic material, stabilizer, and one or more colorants to result in a mixture; and
a melting unit adapted to melt said mixture resulting in said partially liquefied mixture of plastic.

9. The system of claim 8, wherein said plastic material comprises Polypropylene.

10. The system of claim 8, wherein said stabilizer comprises ultraviolet stabilizer.

11. The system of claim 5, further comprising:
an annealing oven adapted to anneal the plastic panel.

12. The system of claim 5, wherein the channel indenting assembly comprises a controller adapted to perform at least one of the following operations:
determining to perform a subsequent pressing of a particular heating element;
determining to terminate subsequent pressing by a particular heating element;
modifying a temperature of a particular heating element;
modifying a time-length in which a particular heating element is to press onto the plastic panel;
modifying a time interval between two consecutive presses of a particular heating element onto the plastic panel.

13. A method of producing a plastic panel, the method comprising:
applying pressure to a partially liquefied mixture of plastic such that the mixture is forced through a dye including openings defining first and second walls and a set of connecting structures, wherein said walls are generally parallel to one another and generally perpendicular to said connecting structures;
pressing a channel in at least one wall of the panel by pressing a heated channel pressing element against a wall; and
regulating power delivery to a heating element connected to the channel pressing element based on a signal received from a temperature sensor functionally associated with the heating element.

14. The method of claim 13, wherein said signal received from said sensor comprises one or more of:
temperature of a heating element,
temperature of a channel, and
temperature of a region of the plastic panel in proximity to a channel.

15. The method of claim 13, further comprising:
deriving a work function associated with the heating element based on a set of signals received from one or more temperature sensors.

16. The method of claim 13, further comprising:
mixing plastic material, stabilizer, and one or more colorants to result in a mixture; and
melting said mixture to result in said partially liquefied mixture of plastic.

17. The method of claim 13, further comprising:
annealing the plastic panel.

18. The method of claim 16, wherein said plastic material comprises Polypropylene.

19. The method of claim 16, wherein said stabilizer comprises ultraviolet stabilizer.

20. The method of claim 13, further comprising:
controlling a set of heated channel pressing elements by performing at least one of the following operations:
determining to perform a subsequent pressing of a particular heated channel pressing element;
determining to terminate subsequent pressing by a particular heated channel pressing element;
modifying a temperature of a particular heated channel pressing element;
modifying a time-length in which a particular heated channel pressing element is to press onto the plastic panel;
modifying a time interval between two consecutive presses of a particular heated channel pressing element onto the plastic panel.
